(19) United States
(12) Patent Application Publication
(10) Pub. No.: US 2002/0029128 A1
(43) Pub. Date: Mar. 7, 2002

(54) Method and apparatus for three-dimensional coordinate determination

(76) Inventors: Barbara Lynn Jones, Kings Lynn (GB); Paul Smith, Kings Lynn (GB)

Correspondence Address: Harold V. Stotland, Seyfarth Shaw, 42nd Floor, 55 East Monroe Street, Chicago, IL, 60603-5803, US

(21) Appl. No.: 09/945,475

(22) Filed: Aug. 30, 2001

(30) Foreign Application Priority Data
Sep. 4, 2000 (GB) 0021637.4

(51) Int. Cl. G01C 9/00; G06F 15/00; G01C 17/00; G01C 19/00

(52) U.S. Cl. 702/152

(57) ABSTRACT

A method and apparatus for three-dimensional coordinate determination in automotive crash repair and diagnostics and other uses provides location-defining means in the form of a pointer having an angularly displaceable end portion and corresponding angular displacement sensing means adapted to feed a signal to the data processing system to enable continuous monitoring of the instantaneous coordinates of the relevant portions of the pointer for mapping purposes whereby access to difficult locations and one-step mapping of planar surfaces can be carried out.

### BACKGROUND

This method and apparatus provides for three-dimensional coordinate determination adapted for automotive crash repair and diagnostics and other uses. An embodiment of the method and apparatus of particular (but not exclusive) utility relates to the use of a such a method and apparatus for such crash repair and diagnostics utilizing a hand-held wand or baton-style device for identifying locations of which the three-dimensional coordinates are to be determined. However, other embodiments utilize plug-in and otherwise hands-free location-defining elements. Embodiments of the method and apparatus are equally applicable to acoustically-based and optically-based and other energy-based transmission systems in which three-dimensional coordinates are determined on the basis of quantitative evaluation of the transmission of an energy signal between receiver and transmitter means in which coordinates are calculated on a geometrical basis. Such techniques are generally known and disclosed for example in: WO 93/04381 and U.S. Pat. No. 4,811,250 in relation to acoustic systems, and WO 98/11405 in relation to an optical system.

A significant limitation of currently available three-dimensional coordinate determination techniques arises from the fact that they are mainly only capable of determining the coordinates of (for example) defined locations on a vehicle and/or of locations which are effectively just touched by the tip of a wand or pointer, and the information obtained is limited to that which relates to and defines the three-dimensional location which is touched by the pointer or defined by the plug-in attachment thereto (or other end fittings).

This is fine so far as the carrying out of the specific task of verifying the three-dimensional location of known and defined reference points on a vehicle, so as to determine their conformity with data relating to the new vehicle, for example. However, particularly in the diagnostics field, there is a considerable need for more versatility. For example, when dealing with a wide variety of crashed vehicles the absence of a uniform standard for end fittings leads to a requirement for a considerable range of such fittings which are interchangeable. These have to be matched to the particular vehicle under test and the computer system needs to be manually instructed as to the type and dimensional characteristics of the fittings accordingly. Also, there is a need in the diagnostics field for an ability to deal with three-dimensional mapping in the situation where there are not necessarily available convenient and undamaged sockets to receive the end fittings of a three-dimensional mapping pointer. Likewise, there is a need to be able conveniently to carry out mapping operations in relation to non-orthogonal structures such as McPherson struts, points on angled chassis structures and the like.

To some extent, existing equipment could be used as a basis for mapping such non-orthogonal surfaces. For example, this could be attempted in terms of taking the coordinates of a series of points extending lengthwise of such a surface and instructing the computing system to process the data accordingly in terms of these points defining a surface of which the attitude and orientation is to be determined. Such a procedure is laborious however, and represents a complicated procedure which is not conducive to effective utilization of the equipment in the environment of high-speed automotive diagnostics situations.

Equally, it might be possible to take an alternative approach to the determination of the attitude of non-orthogonal surfaces by utilizing an existing wand or pointer device in which a side face of (perhaps the end portion of) that device is caused by the operator to lie in face-to-face contact with the surface to be mapped, and the computer system is instructed that such side face of the device represents the attitude of the surface to be mapped. Such an approach can lead to significant practical difficulties in terms of the complications of use of the device, as mentioned above, and not to mention the practical difficulty that the required attitude of the device for this purpose may inhibit or prevent effective signal transmission between the transmission and receiver apparatus of the system as well as difficulties in terms of access in locating the device in relation to the vehicle.

Yet another requirement relevant to the above-identified need for improved versatility in equipment of this kind relates to dealing with the mapping of relatively inaccessible locations on the vehicle. To some extent this problem has been tackled in the U.S. Pat. No. 250 specification identified above in which the knee joint 112 in FIG. 4C of that specification enables a plug-in arrangement to be adopted in a right-angled sensor or pointer configuration which permits access to a socket where, perhaps, a linear sensor could not gain access or at least could not do so conveniently.

The disclosure in the U.S. Pat. No. 250 specification in relation to the knee join 112 (identified in that specification) does not deal in detail with the computing aspects ofthe mapping operation where the orthogonal knee joint is utilized as shown in FIG. 4C. The geometry of the assembly as seen in that figure needs to be supplied to the computer for it to be able to calculate the geometric relationship between the knee joint assembly and the main body of the sensor or wand, which serves to transmit (or receive) the energy signals for reference purposes.

Accordingly, it can now be seen that there is a considerable need for improvements in relation to the use of three-dimensional mapping equipment for example in relation to automotive diagnostics uses, in which versatility is improved and/or the requirement for multiple end fittings is reduced and/or the ability to carry out mapping operations in relation to non-orthogonal surfaces is improved and/or the ability to carry out mapping operations in relation to less than perfectly accessible locations is improved and/or improvements generally in relation to one or more of the matters discussed above or other requirements are provided.

According to the method and apparatus there is provided the method and apparatus as defined in the accompanying claims.

### SUMMARY

In an embodiment of the method and apparatus described below there is provided a method and apparatus in which three-dimensional mapping apparatus comprises location defining means which itself comprises a reference portion and a sensor portion. These portions are interconnected so as to be positionally displaceable with respect to each other. Sensor means are provided and adapted to sense and signal position displacement between the portions. In the described embodiments the position displacement is angular displacement, but endwise or lengthwise displacement maybe provided, with corresponding sensing means, whereby an increase in versatility is likewise obtained. In the embodiments the signal from the angular displacement sensing means provides an immediate basis for the computer system to calculate the instantaneous exact position of the displaceable portion of the location defining means (such as an end portion or an attachment thereto) for multiple three-dimensional mapping steps carried out by the apparatus.

In simple terms, the user can carry out a sequence of multiple mapping steps using a single location defining means, and without the need to apply end fittings (though such may be of benefit for certain operations) and the sensing portion of the location defining means can be adjusted in position/attitude between successive ones of these mapping steps in order to accommodate the variables of the topography of the surfaces and features of the vehicle being mapped, and all such adjustments are automatically included in the computing steps of the mapping operation without the need for any instructions on the part of the user.

In the case where a non-orthogonal surface is to be mapped then the attitude of any given planar surface to be mapped can be determined in one step by placing a suitable reference face ofthe sensing portion of the location defining means against such face, and the computer system can then readily compute the relevant coordinates of the selected face.

To put it another way, the provision of position sensing (for example angle-sensing) means signaling the relative position of a sensing portion and a reference portion of the location defining means and arranging for the generated signal to be provided continuously (or at selected intervals) to the computing system of the three-dimensional mapping apparatus adds to that apparatus a whole range of coordinate mapping step possibilities which entirely fill the gaps left by the limited versatility of the previously known apparatus which can operate effectively only in relation to mapping the coordinates of specific individual points in space, one at a time, and in relation only to predetermined or fixed (mainly linear or orthogonal) configurations of the apparatus.

By providing for a system in which displacement data (usually but not exclusively angular displacement data) is continuously fed or fed at suitable intervals into the computing system which carries out the three-dimensional mapping calculations, substantial advances in the utility of the resultant mapping data can be achieved.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 shows a schematic representation of a three dimensional measurement system with which a location defining probe and method are used;

FIG. 2 shows a schematic representation of a location defining probe according to a first embodiment;

FIG. 3 illustrates the use of the location defining probe shown in FIG. 2 to measure the position and orientation of a feature or surface in accordance with the present method and apparatus;

FIG. 4 shows a schematic representation of a location defining probe according to a second embodiment of the present method and apparatus; and

FIG. 5 shows a schematic representation of a location defining probe according to a third embodiment.

### DETAILED DESCRIPTION

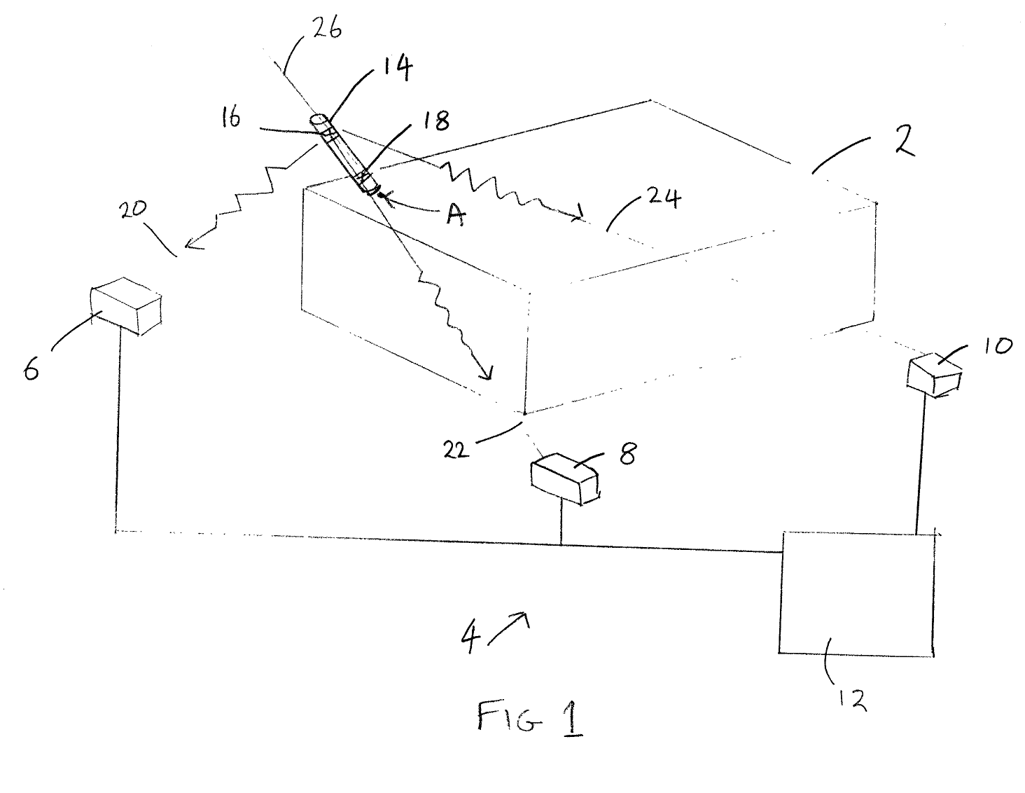

Apparatus 4 for three-dimensional coordinate determination adapted for determining the positions of parts of an automotive vehicle 2 in automotive crash repair and diagnostics is shown schematically, in FIG. 1. The apparatus 4 comprises a number of spaced apart fixed receiver means 6, 8, 10 connected to a data processing means 12, typically a computer system. The receiver means 6, 8, 10 are disposed at fixed spaced apart positions around the vehicle 2. A location or position defining means in the form of a probe 14 includes a pair of transmitter means 16, 18 which are spaced apart, aknown separation along the probe 14. Each ofthe transmitter means 16, 18 transmits an energy signal 20, 22, 24 to the receiver means 6, 8, 10 where the signal 20, 22, 24 is detected. The data processing means 12 is adapted to process data derived from the transmission and detection, of the energy signal 20, 22, 24 between the transmitter 16,18 and receiver means 6, 8, 10 to determine, typically by triangulation algorithms, the three-dimensional coordinates of the transmitter means 16,18 relative to the receiver means 6, 8, 10. In FIG. 1 only energy signals 20, 22, 24 from one transmitter 16 have been shown in the interest of clarity. Similar signals are however transmitted from the other transmitter 18 mounted on the probe 14. The positions ofthe pair of transmitter means 16,18 of the probe 14 can therefore be determined relative to the fixed receiver means 6, 8, 10. The disposition of the transmitter means 16,18 within the probe 14 are fixed, and preferably the transmitter means 16,18 are coaxially mounted within the probe 14. The data processing means 12 can therefore from the positional information of the transmitter means 16,18 locate the axis 26 of the probe 14, its orientation and position.

It should be appreciated though that although as described, the receiver means 6, 8, 10 are fixed and the transmitter means 16,18 are located on the probe the positions could be reversed. Also the number of transmitter means and receiver means can be altered to provide improved accuracy, wider fields of view/detection and/or provide a degree of redundancy such that the system 4 can operate even if one of the transmitter or receiver means is inoperative or obstructed when making a particular measurement. In general though the above described arrangement is the practical minimum.

To determine the coordinates of various points and features of the vehicle the probe 14, and in particular one end or tip part 25 of the probe 14, and in particular one end or tip part 25 of the probe 14, is applied to a series of identifiable points A on the vehicle 2 to be mapped. The position of the probe 14, determined from the energy signal 20, 22, 24 transmitted from the probe transmitter means 16, 18, when the probe 14 is located at these points A provides an indication of the position of the point A. Such measurements are all relative to the fixed receiver means 6, 8, 10 positions which define a reference frame from which the 3 dimensional measurements that are made using the apparatus and system 4 can be related. In this way the relative positions of the various points A on the vehicle 2 can be determined and compared, and within a diagnostic or repair situation compared with known relative positions to give an indication of any variance.

As such the basic system outlined above, and within which the method and apparatus as described below is used, is generally conventional and known to those skilled in the art. In particular similar such systems are described in U.S. Pat. No. 4,811,250 and WO 93 04381 based upon using acoustic transmitter and receiver means, and also in WO 98/11405 for an optically based system. These prior patents are therefore incorporated herein by reference, and reference should be made to them, to the extent that they describe the general type of system with which the method and apparatus is used and provides improvements thereto. It should also be appreciated that there are other generally similar such systems with which the method and apparatus, probe 14 and the principles thereof can be applied.

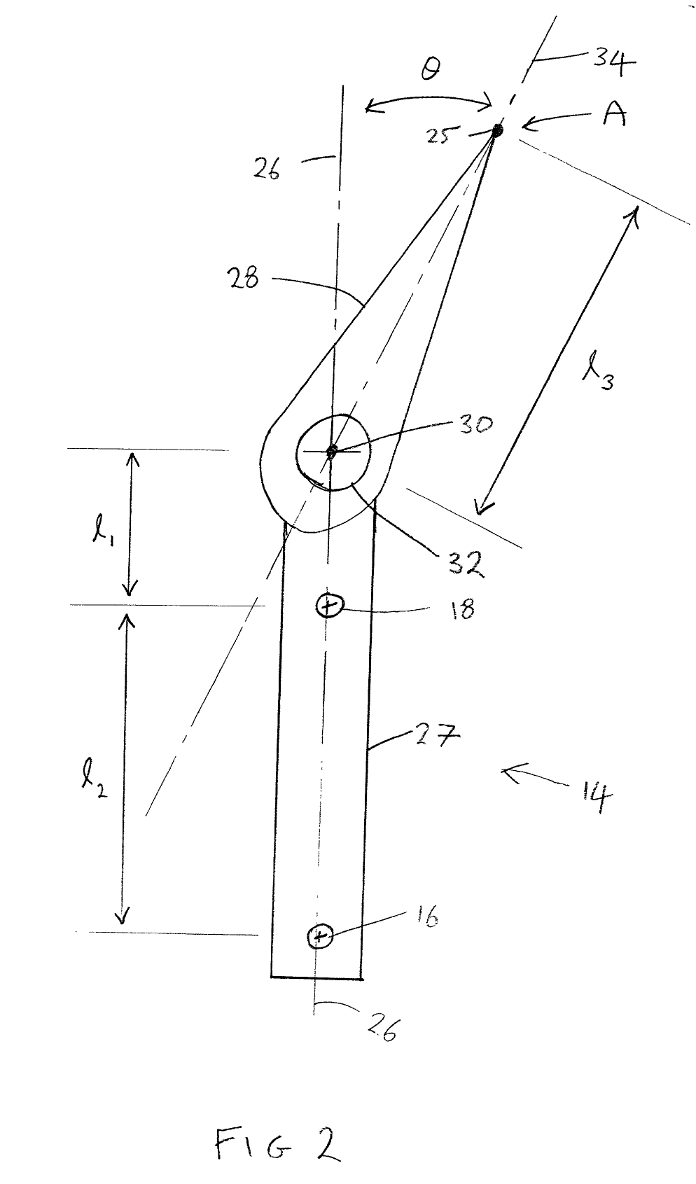

Referring to FIG. 2, this shows a schematic of an embodiment of a probe 14, which is the key part of the method and apparatus, in more detail. The probe 14 comprises an elongate main body or reference portion 27 having a central main probe axis 26. Housed within the main body 27 are the pair of transmitter means 16, 18. These are located at defined positions, preferably coaxially with respect to the central main probe axis 26 in a similar manner as in conventional probes. As such, in use, the position of the main body 27 of the probe 14 and central main probe axis 26 position and orientation can be determined by the data processing means 12 as described above in relation to conventional systems.

The probe 14 also includes a tip or displaceable portion 28 which is pivotally mounted at one end ofthe main body portion 27 and can pivot about a pivot axis 30 relative to the main body portion 27 of the probe 14. This pivoting tip portion 28 can be pivoted about the pivot axis 30 to a number of varied angular positions. Accordingly this tip portion 28 and angling thereof allows, in use, the end 25 of the tip portion 28, to more easily access parts and points A of the vehicle which may be inaccessible to a conventional linear probe. Furthermore since the angle of the tip portion 28 can be varied it can be adjusted to a wide variety of positions thereby proving a more versatile probe 14 suited to use in measuring a varied number of different types of points A located on a vehicle 2. In addition pivoting of the tip portion 28 relative to the main body 27, allows the end 25 of the tip portion 28 which is to be located on apoint A onthe vehicle to be measuredto be suitably positioned whilst the main body 27, housing the transmitters 16,18, can be positioned and pivoted such that the signals 20, 22, 24 from the transmitters 16,18 can be optimally or at least better, received by the receiver means 6, 8, 10. Such advantages are not provided or capable of being provided by using a conventional fixed probe.

A rotary angular position sensor 32 is provided within the probe 14 between the tip portion 28 and main body 28 and is adapted to measure the angle θ of the tip portion 28, and axis 34 thereof, relative to the main body portion 27 and a second part fixed to the tip portion 28. Pivoting of the tip portion 28 relative to the main body 27 causes relative movement between the first and second parts ofthe rotary potentiometer. This is arranged to vary the resistance ofthe rotary potentiometer. This resistance is therefore indicative of the relative positions of the first and second parts of the potentiometer and accordingly provides a measure and indication of the angle or displacement 8 of tip portion 28 (specifically the axis 34 ofthe tip portion) to the mainportions (specifically the central axis 26). Suitable electronic circuitry (not shown) within the probe 14 is arranged to transmit (either continuously or at specific times) a signal indicative of the resistance and therefore of the angle 8 to the data processing means 12.

In operation the data processing means 12 processes the signals 20, 22, 24 from the transmitters 16,18 in conjunction with the known separation 12 ofthe transmitters 16, 18 within the probe 14 and known disposition of the transmitters 16,18 relative to the main body axis 26. As a result, and as with conventional probes, the position ofthe main body or reference portion 27 of the probe 14 and the orientation of the main probe body axis 26 is determined. In addition the data processing means 12 also receives a signal providing information and an indication of the angle A of the tip portion 28 of the probe 14 relative to the main body 27 of the probe 14 from the rotary sensor 32. Using this angle A, and known fixed details of the length 13 of the tip portion 28, the position relative to the pivot axis 30 and main body 27 of the very end 25 of the tip portion 28 can also now be directly determined by the data processing means 12. This end portion 25 being the part of the probe 14 which touches and/or sensing portion of the probe 14, with the rotary sensor 32 relating the relative positions of these two portions 27,28 of the probe 14. In other words with such a probe 14, the main body 27 of the probe 14 provides an intermediate reference portion for the tip 25 and/or sensing portion of the probe 14, with the rotary sensor 32 relating the relative positions of these two portions 27, 28 of the probe 14.

The position of the pivot axis 30 (specifically distance from the transmitters 18,16 and disposition relative to the main probe axis 26) relative to the main body 27 is known and fixed. The data processing means 12 can therefore, using simple algorithms determine and combine the relative position of the end 25 of the tip portion 28 relative to the pivot axis 30 with the relative position of the main body portion 27, to provide accurate positional information of the end 25 of the tip portion 28 relative to the receivers 6, 8, 10 and fixed reference frame of the system as a whole at any of a range of angular positions.

By incorporating rotary position sensor 32 within the probe to provide a measure (angle θ) of the (relative position (relative to main body or reference portion 27) of the tip portion 28 (and its actual end 25) at which the measurements points A of the vehicle 2 are taken, a more accurate measurement can be made than is often achieved with prior art linear or orthogonal probes or pointers which rely on forcing the user to accommodate such systems to the nonlinear and non-orthogonal structures of vehicles with attendant losses of accuracy.

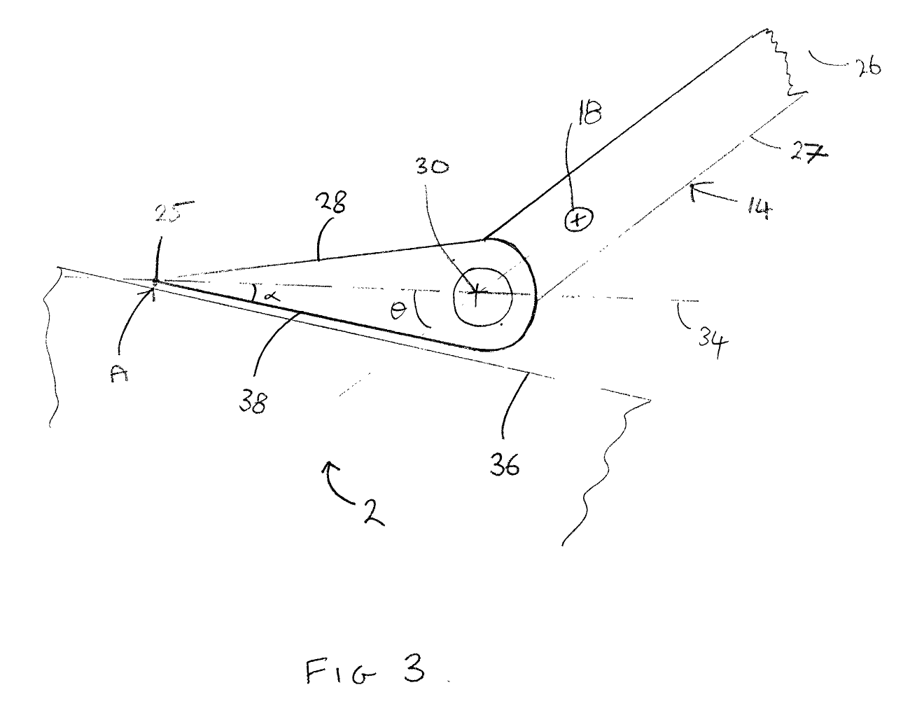

Referring to FIG. 3, an additional aspect and feature of the probe 14 with a pivoting displaceable or tip portion 28 and including a rotary position sensor 32 to provide information of the relative angle θ of the tip portion 28 to the reference portion or main probe body 27, is shown. The tip portion has a planar edge surface 38. In use the reference planar edge surface 38 ofthe tip portion 28 is positioned and abutted against a local planar surface 36 ofthe vehicle 2. It should be noted that the probe 14 as a whole, and in particular the main body portion 27 does not need to be located orthogonally with respect to the surface 38 being measured. The tip portion 28 pivots about the pivot axis 30 and relative the main probe body 27 to allow the reference surface 28 of the tip portion 28 to abut and be pressed against the local vehicle surface 36. The relative angle α of the tip reference surface 38 to the axis 34 of the tip or sensor portion 28 is fixed and known for the particular tip portion 28. The angle θ of the tip portion axis 34 relative to the main probe axis 26 is indicated and provided by the rotary sensor 32. Consequently the data processing means 12, using the indication of the angle θ, can determine the orientation ofthe reference surface 38 ofthe tip portion 28 relative to the axis 26 of the main probe body 27. The orientation of the main probe body axis 26 is calculated from the signal received from the transmitters 16,18 mounted thereon as usual. As a result, by combining these measurements of the orientations, the orientation of the reference surface 38 of the tip portion 28 can be determined by the data processing means 12 using simple algorithms. Since the reference surface 38 is pressed against the local vehicle surface 36 the orientation of the tip reference surface 38 equates to the orientation of the local vehicle surface 38. Therefore in this way, and using this probe 14, the orientation of the local vehicle surface 36 relative to the reference frame can be determined and provided in a single operation by simply pressing and placing the tip portion 28 of the probe 14 against the surface 36 of the vehicle 2 to be measured at a single point A.

This can be contrasted with conventional methods using conventional probes in which in order to determine the orientation of a feature or surface, the position of a number of points on the surface/feature have to be individually determined with the data processing means 12 then processing this positional information to determine the orientation of a plan/vector passing through such points.

Furthermore since the tip portion 27 of the probe 14 is relatively small and can be pivoted with respect to the main probe body, the tip portion 28 and reference surface 38 of the tip portion 28 can easily be pressed against the particular local surface 38 to be measured. The pivoting tip portion 28 can also more easily access and be orientated to abut against a number of varied differently orientated surfaces of the vehicle 2. This can also be contrasted with conventional fixed probes in which, if by way of suitable fittings they do provide a reference surface, the orientation is fixed relative to the main probe body (usually orthogonal) such that, due to space/access constraints, they cannot be located on some particular vehicle surfaces to be measured. Alternatively custom fittings are used which adds complexity and requires specific geometrical information for the particular fittings to be manually entered. Also with this probe 14 since the rotary sensor 32 provides automatic information of the orientation of the reference surface 38, by means of transmitting the relative angle θ of the tip portion 28, to the data processing means 12 there is no need for an operator to provide details ofthe orientation of the reference surface 38 relative to the probe axis 26 to the data processing means 12 as is the case with conventional probes incorporating multiple varied angled attachments and angled reference surfaces.

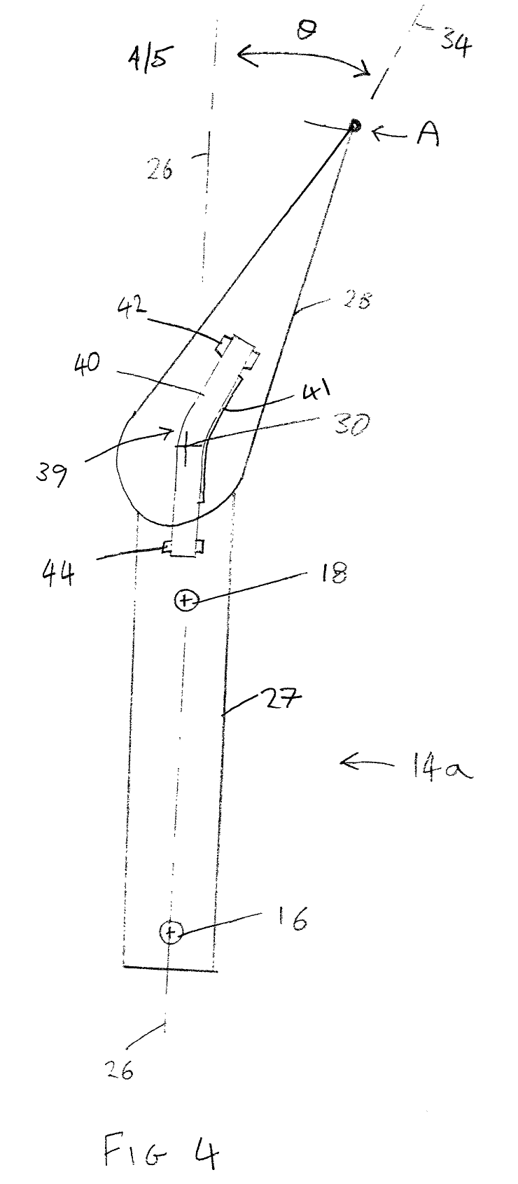

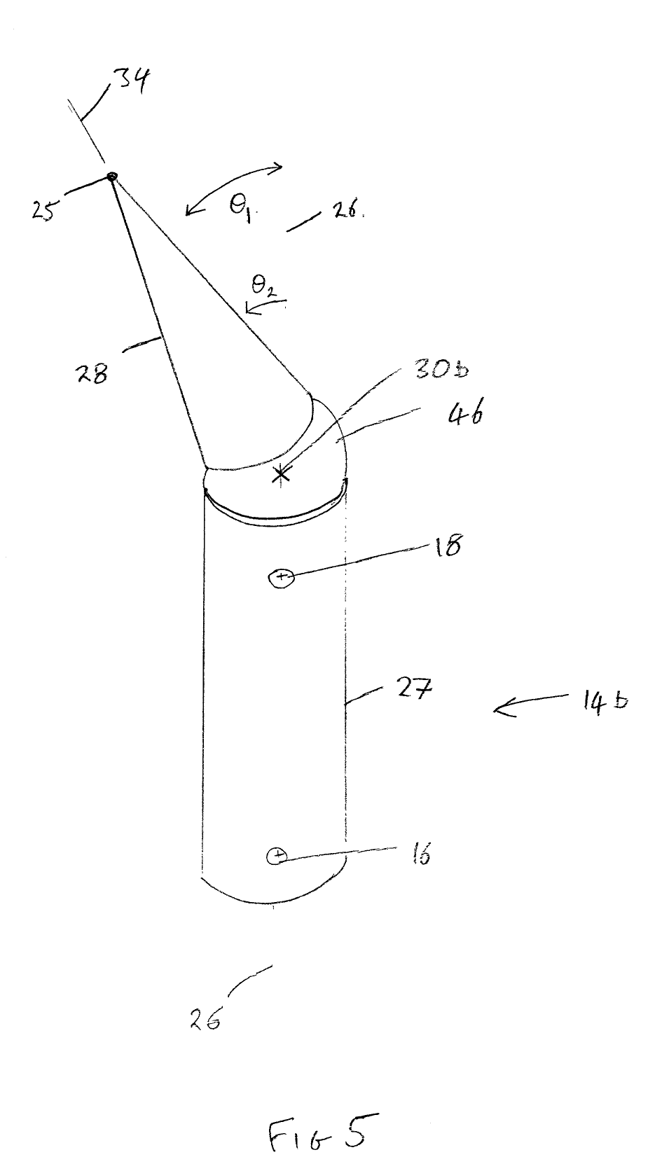

FIGS. 4 and 5 show alternative probes 14a, 14b according to further embodiments of the method and apparatus. These probes 14a, 14b are generally similar to the probe 14 described above and similarly comprise a main body portion 27 which provides a reference portion to a tip or sensing portion 28 of the probe 14, 4a, 14b, with a positional sensing means 32 providing and transmitting relative positional information of the two portions 27, 28. Like reference numerals have therefore been used for like features of the alternative probe embodiments and only differences between these embodiments and the probe and system described above will be mentioned.

In the probe 14a shown in FIG. 4 the potentiometer means 32 which provided the rotary position sensor 32, is replaced by a fibre optical angular measurement sensor 39. Such a fibre optic angular position sensor 39 is generally known in the art and is described in U.S. Pat. No. 5,321,257, which accordingly is incorporated herein by reference and to which reference should be made for the exact details of such a sensor system. It will be appreciated that it is the application of such a sensor 39 to a measurement probe 14a rather than the specific details of the fibre optic sensor 39 that are significant in the present method and apparatus. In summary, such a fibre optic sensor 39 comprises a sensing length of fibre optic 40 having a light emissive surface 41 extending in a thin band along one side of the fibre 40, and suitable electronic sensor circuitry (not shown). The light emissive surface 41 can be merely an exposed surface or textured, for example having serrations, corrugations or roughness. Light is directed along the fibre 40 and the amount of light transmitted through the fibre 40 is measured by the sensor circuitry and ancillary means. Bending of the sensing length of fibre optic 40 alters the incidence of light transmitted through fibre optic 40 on the light emissive surface portion 41. This change in incidence varies the amount of light transmitted through the fibre optic/lost due to the emissive portion 41. Consequently as the sensing length 40 is bent differing amounts of light are transmitted through the fibre optic length 40. This variation in the amount of light transmitted is related to the incidence of light on the emissive surface 41 and so to the angle of bending of the fibre optic length 40. Therefore by measuring the amount of light transmitted a measure of the angle at which the fibre optic length 40 is bent is given.

As shown, a sensing length of fibre optic 40 is located between the main probe body 27 and tip portion 28 with one end of the sensing length of fibre optic 40 fixed 44 to the main body 27 and the other attached 42 to the tip portion 27. The fibre optic sensing length 40 is thereby arranged such that pivoting of the tip portion 28 bends the sensing length of fibre optic 40 about the pivot axis 30. The emissive surface portion 41 ofthe sensing length 40 is disposed along one side of the fibre optic sensing length 40 so that as the tip 28 and main body 27 portions pivot the fibre optic sensor 39 provides a measure of the angle θ of the tip portion 28 relative to the main body portion 27. Specifically the fibre optic sensor 39 provides an indication of the angle θ of the tip axis 34 relative to the main probe body axis 26. In the same way as with the previous embodiment this measurement of the angle 6 is then transmitted to the data processing means 12 and treated in the same way as the indication of the angle θ produced by the potentiometer rotary position sensor 32.

An advantage ofthe fibre optic sensor 39 to measure the angle θ of the tip portion 28 relative to the main body portion 27 is that the such a fibre optic sensor 39 is relatively small and light. It can therefore be more easily accommodated within a smaller probe 14a and in particular smaller tip portion 28. The relevant detection and drive circuitry for the sensor 39 and also for transmitter means 16, 18 can also conveniently be located remotely from the tip portion 28 and pivot axis 30. For example such circuitry can be located on the other end of the main body probe 27. It will be appreciated that a smaller probe 14a and in particular a smaller pivoting tip portion 28 is advantageous to particular in terms of being able to access particular positions and points of a vehicle 2 which are to be measured.

In yet further embodiments of the method and apparatus other types of rotary or angular position sensors can be used to measure and indicate the angle 6 and relative positions of the tip portion 28 relative to the main body portion 28 of the probe. For example an optical shaft encoder could be provided and used in a similar way to the rotary potentiometer 32.

In the embodiments described so far the tip portion 28 pivots relative to the main body 27 in one direction about a single pivot axis 30. In an alternative further embodiment the tip portion 28 of the probe 14b can be pivotally mounted to the main body 27 via a spherical pivoting joint 46 such that the tip portion 28 can pivot about a central pivot point 30b, as opposed to a single axis. In this way the tip portion 28 can be moved and pivoted relative to the main body 27 in almost any direction allowing the tip portion 28 and end 25 of the tip portion 28 to even more easily access and be positioned on a particular point A or surface 36 to be measured.

In such an arrangement two angles θ₁, θ₂ need to be measured and transmitted to the data processing means 12 in order to determine the relative orientation of the tip axis 34 relative to the main probe axis 26 and therefore the relative position of the end 25 of the tip portion 28. The principles however are identical.

One suitable means to measure these angles θ₁, θ₂ is to use two fibre optic sensors, similar to those described above, mounted between the tip portion 28 and main body 27 of the probe 14b about the pivot point 30b. These sensors are arranged to measure pivot angles θ₁, θ₂ about the pivot point 30b in respective orthogonal directions, with the emissive surfaces of each fibre optic sensing lengths accordingly disposed along respective orthogonally directed sides of the respective fibers. The use of multiple fibre optic sensors and sensing lengths to measure angularbending/displacement in more than one direction is also described in U.S. Pat. No. 257 referred to above.

It will be appreciated though that other suitable measurement means and angular sensors known in the art can be used to provide such measurements of these angles θ₁, θ₂.

In these embodiments the tip portion 28 is of a pointer form with the end point 25 applied to the particular point A to be measured. This is generally the most preferable form since it is particularly flexible in terms of use and provides a probe which is particularly adaptable to measuring different types of points A. It will be appreciated though the other forms and shapes for the tip portion 28 can be used depending upon the particular intended use and specific application ofthe probe. In particular the tip portion 28 may include attachment features to allow the tip portion 28 of the probe to be fitted to bolt or coordinate reference holes in the vehicle 2.

The matter set forth in the foregoing description and accompanying drawings is offered by way of illustration only and not as a limitation. While particular embodiments have been shown and described, it will be obvious to those skilled in the art that changes and modifications may be made without departing from the broader aspects of applicants' contribution. The actual scope ofthe protection sought is intended to be defined in the following claims when viewed in their proper perspective based on the prior art.

What is claimed is:

1. An apparatus for three-dimensional coordinate determination characterized by a location-defining probe comprising a reference portion and a displaceable portion having a displacement sensor connected therebetween and adapted to generate a displacement signal, and the apparatus being adapted to feed the displacement signal to a data processor to process same in association with data relating to an energy transmission signal transmitted between a transmitter and receiver of which one of same is associated with the location-defining probe, to determine the three-dimensional coordinates of selected locations of a vehicle or other structure at any of a range of selectable displacements of the displaceable portions of the location defining probe when placed at the selected locations of the vehicle.

2. The three dimensional coordinate determination apparatus of claim 1 wherein the displaceable portion of the location-defining probe includes a pivoting tip portion that is pivotally mounted at the end of a main body portion of the location defining probe.

3. The three dimensional coordinate determination apparatus of claim 2 wherein the displacement sensor comprises a rotary angle position sensor.

4. The three dimensional coordinate determination apparatus of claim 3 wherein the rotary angle position sensor includes a rotary potentiometer.

5. The three dimensional coordinate determination apparatus of claim 4 wherein the rotary potentiometer generates a defined resistance based on the position of the pivoting tip portion so that the position may be determined by the data processor according to a predetermined algorithm.

6. The three dimensional coordinate determination apparatus of claim 3 wherein the rotary angle position sensor includes a fiber optical angular measurement sensor.

7. The three dimensional coordinate determination apparatus of claim 3 wherein the rotary angle position sensor includes an optical shaft encoder.

8. The three dimensional coordinate determination apparatus of claim 2 wherein the pivoting tip portion pivots relative to the main body of the probe in one direction about a single pivot plane.

9. The three dimensional coordinate determination apparatus of claim 2 wherein the pivoting tip portion pivots about a spherical pivoting joint providing rotation in multiple pivot planes.

10. The three dimensional coordinate determination apparatus of claim 1 adapted for repair or diagnostics or other operations pertaining to vehicles.

11. A method of three-dimensional coordinate determination adapted for automotive crash repair and diagnostics, the method comprising:
a) the step of providing coordinate data evaluation apparatus comprising location-defining means and transmitter means and receiver means and data processing means adapted to process data derived from the transmission of an energy signal between the transmitter and receiver means to determine information with respect to the three-dimensional coordinates of the location-defining means associated with one of the transmitter means and the receiver means with respect to the other thereof, the one of the means being mounted on the location defining means, and the location defining means comprising a reference portion and an angularly displaceable portion; and
b) the step of carrying out a series of coordinate data evaluation steps with the apparatus in which the location-defining means is applied to a series of identifiable or pre-determined locations on a vehicle while the energy signal is transmitted and the other of the transmitter or receiver means is located at another location; characterized by
c) the step of providing angular displacement sensing means connected between the reference and angularly displaceable portions of the location-defining means and adapted to generate an angular displacement signal; and
d) the step of feeding the angular displacement signal to the data processing means and processing same in association with data relating to the energy transmission signal to determine the three-dimensional coordinates of the locations on the vehicle at any of range of selectable relative angular displacements of the portions of the location-defining means.

12. A method of three-dimensional coordinate determination adapted for repair or diagnostics or other operations characterized by providing location-defining means comprising a reference portion and a displaceable portion having displacement sensing means connected there between and adapted to generate a displacement signal, and the method comprising the step of feeding the displacement signal to data processing means and processing same in association with data relating to an energy transmission signal transmitted between transmitter and receiver means, of which one of same is associated with the location-defining means, to determine the three-dimensional coordinates of selected locations on a vehicle or other structure at any of a range of selectable displacements of the displaceable portions of the location-defining means.

13. A method according to claim 12 characterized by the step of adjusting the relative displacements of the portions of the location-defining means between applying same to at least two of a sequence of the locations on the vehicle or other structure.

14. A method according to claim 12 characterized by the step of providing a planar surface at or in the end region of the displaceable portion of the location-defining means and causing the data processing means to determine the coordinates of the planar surface when the latter is applied face-to-face to a planar or semi-planar surface of a structure to be mapped.

15. A method according to claims 14 characterized by providing the displaceable portions interconnected by joint means permitting relative angular movement in more than one plane and providing the displacement sensing means adapted to sense and provide signals accordingly and by the step of processing the signals for the coordinate data determination purposes.

16. Apparatus for three-dimensional coordinate determination adapted for automotive crash repair and diagnostics, the apparatus comprising:
a) coordinate data evaluation apparatus comprising location-defining means and transmitter means and receiver means and data processing means adapted to process data derived from the transmission of an energy signal between the transmitter and receiver means to determine information with respect to the three-dimensional coordinates of the location-defining means associated with one of the transmitter means and the receiver means with respect to the other thereof, the one of the means being mounted on the location defining means, and the location-defining means comprising a reference portion and an angularly displaceable portion; and
b) the apparatus being adapted to carry out a series of coordinate data evaluation steps in which the location defining means is applied to a series of identifiable or pre determined locations on a vehicle while the energy signal is transmitted and the other of the transmitter or receiver means is located at another location;
characterized by
c) angular displacement sensing means connected between the portions of the
location-defining means and adapted to generate to angular displacement signal;
and
d) signal feed means for feeding the angular displacement signal to the data processing means for processing same in association with data relating to the energy transmission signal to determine the three-dimensional coordinates of the locations on the vehicles at any of a range of selectable angular displacements of the portions of the location-defining means.

17. Apparatus for three-dimensional coordinate determination adapted for repair or diagnostics or other operations characterized by location-defining means comprising a reference portion and a displaceable portion having displacement sensing means connected there between and adapted to generate a displacement signal, and the apparatus being adapted to feed the displacement signal to data processing means to process same in association with data relating to an energy transmission signal transmitted between transmitter and receiver means of which one of same is associated with the location-defining means, to determine the three-dimensional coordinates of selected locations on a vehicle or other structure at any of a range of selectable displacements of the portions of the location defining means.

18. Apparatus according to claim 17 characterized by a planar surface being provided at or in the end region of the displaceable portion of the location-defining means and the data processing means being adapted to determine the coordinates of the planar surface when the latter is applied face-to-face to a planar or semi-planar surface of a structure to be mapped.

19. Apparatus according to claim 18 characterized by the portions being interconnected by joint means permitting relative angular movement in more than one plane and the displacement sensing means adapted to sense and provide signals accordingly and the data proceeding means being adapted to process the signals for the coordinate data determination purposes.

20. Location defining means for use in a method according to claim 12 and comprising relatively displaceable reference and displaceable portions and characterized by of displacement sensing means adapted to provide signals relating to the relative displacement for data-processing in accordance with the method.
